(19) United States
(12) Patent Application Publication
(10) Pub. No.: US 2020/0140026 A1
(43) Pub. Date: May 7, 2020

(54) RUBBER CRAWLER

(71) Applicant: BRIDGESTONE CORPORATION, Chuo-ku Tokyo (JP)

(72) Inventor: Ryota KAWAKI, Fujisawa-shi, Kanagawa (JP)

(73) Assignee: BRIDGESTONE CORPORATION, Chuo-ku Tokyo (JP)

(21) Appl. No.: 16/341,126

(22) PCT Filed: Nov. 2, 2017
(86) PCT No.: PCT/JP2017/039762

§ 371 Date: Apr. 11, 2019

(30) Foreign Application Priority Data
Nov. 7, 2016 (JP) 2016-217466

(51) Int. Cl. B62D 55/253; B62D 55/24

(52) U.S. Cl. CPC B62D 55/253; B62D 55/244

(57) ABSTRACT

Provided is a rubber crawler 10 in which a rubber lug 11 is formed on an outer circumferential side of an endless rubber elastic body, cores 12 are disposed in the rubber elastic body at a constant pitch in a crawler circumferential direction, and sprocket engaging holes 13 to be engaged with sprockets S are formed between cores 12 adjacent to each other in the crawler circumferential direction. The sprocket engaging holes 13 are provided with a rubber film 14, which has a shape protruding toward a crawler inner circumferential side.

### TECHNICAL FIELD

This disclosure relates to a rubber crawler.

### BACKGROUND

In a known example of a rubber crawler, cores are disposed at a constant pitch in the crawler circumferential direction in rubber lugs formed on the outer circumferential side of an endless rubber elastic body, and a sprocket S that transmits a driving force is engaged between the cores.

As such a rubber crawler, for example, a rubber elastic crawler provided with a rubber thin layer is suggested, the rubber thin layer covering sprocket engaging recesses engaged with sprockets S from the outer circumferential side of embedded lateral reinforcing cord (core) (see JPS56-86871 A).

### CITATION LIST

### Patent Literature

PTL 1: JPS56-86871 A

### SUMMARY

### Technical Problem

In the conventional rubber elastic crawler, a rubber thin layer is provided. Thus, for example, although mud or the like adhered between rubber lugs on the crawler outer circumferential side can be prevented from entering from the sprocket engaging holes into the rubber crawler, mud or the like adhered between the rubber lugs on the crawler outer circumferential side cannot be removed from between the rubber lugs.

For example, in the case of a rubber crawler for agricultural machinery used in a field, when mud in the field adheres between rubber lugs on the crawler outer circumferential side of the rubber crawler and remains there, a traction force of the rubber crawler is decreased and slip easily occurs during running.

It would therefore be helpful to provide a rubber crawler that can remove mud or the like adhered between the rubber lugs on the crawler outer circumferential side from between the rubber lugs.

### Solution to Problem

A rubber crawler according to this disclosure is a rubber crawler in which rubber lugs are formed on an outer circumferential side of an endless rubber elastic body, cores are disposed in the rubber elastic body at a constant pitch in a crawler circumferential direction, and sprocket engaging holes to be engaged with sprockets are formed between the cores adjacent to each other in the crawler circumferential direction. The sprocket engaging holes are provided with a rubber film, and the rubber film has a shape protruding toward the inner circumferential side of the crawler.

### Advantageous Effect

The rubber crawler according to this disclosure can remove mud or the like adhered between rubber lugs on the crawler outer circumferential side from between the rubber lugs.

### BRIEF DESCRIPTION OF THE DRAWINGS

In the accompanying drawings:

FIG. 1A is a cross-sectional view in a crawler circumferential direction in a normal state, schematically illustrating a rubber film of a rubber crawler according to the disclosed one embodiment, FIG. 1B is a cross-sectional view in the crawler circumferential direction with adhesion of mud or the like, schematically illustrating the rubber film of the rubber crawler according to the disclosed one embodiment, and FIG. 1C is a cross-sectional view in the crawler circumferential direction when adhered mud or the like is removed, schematically illustrating the rubber film of the rubber crawler according to the disclosed one embodiment;

FIG. 2A is a plan view of a crawler outer circumferential side viewed from a lug side of the rubber crawler, illustrating an arrangement of the rubber film in FIG. 1 in the rubber crawler, FIG. 2B is a plan view of a crawler inner circumferential side viewed from an inner circumferential side of the rubber crawler, illustrating an arrangement of the rubber film in FIG. 1 in the rubber crawler, and FIG. 2C is a cross-sectional view taken along line A-D in FIG. 2B, illustrating an arrangement of the rubber film in FIG. 1 in the rubber crawler; and

FIG. 3A is a cross-sectional view in a crawler circumferential direction in a normal state, schematically illustrating a rubber film of a rubber crawler according to the disclosed another embodiment, FIG. 3B is a cross-sectional view in the crawler circumferential direction with adhesion of mud or the like, schematically illustrating the rubber film of the rubber crawler according to the disclosed another embodiment, and FIG. 3C is a cross-sectional view in the crawler circumferential direction when adhered mud or the like is removed, schematically illustrating the rubber film of the rubber crawler according to the disclosed another embodiment

### DETAILED DESCRIPTION

Detailed description will be given below with reference to drawings.

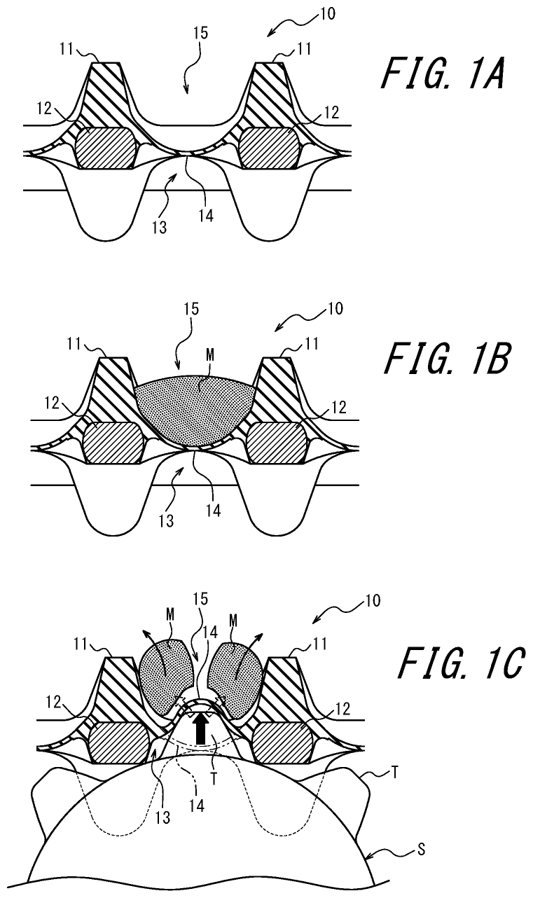

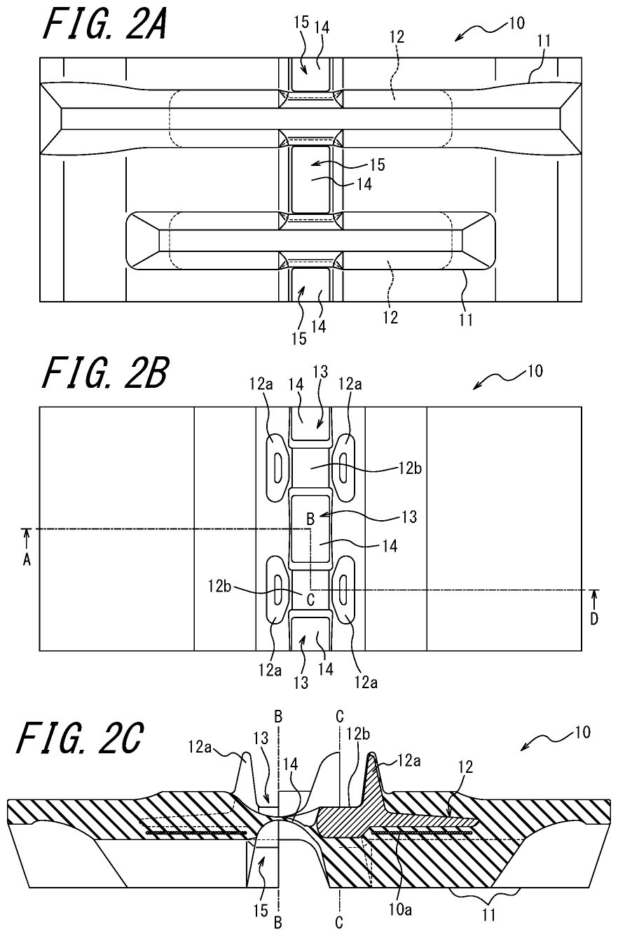

As illustrated in FIGS. 1A to 1C and FIGS. 2A to 2C, in a rubber crawler 10 according to this embodiment, rubber lugs 11 are formed on an outer circumferential side of an endless rubber elastic body, cores 12 are disposed in the rubber elastic body at a constant pitch in a circumferential direction of the rubber crawler 10 (crawler circumferential direction), and sprocket engaging holes 13 to be engaged with sprockets S are formed between cores 12 adjacent to each other in the crawler circumferential direction.

This rubber crawler 10 is a rubber crawler attached to a machine body for agricultural machinery used in a field, for example, and a driving force generated by a driving force generating source provided in the machine body is transmitted to the rubber crawler 10 through the sprockets S on the machine body side.

In this embodiment, the rubber lug 11 is formed by projecting to the outer circumferential side of the rubber crawler 10 (crawler outer circumferential side), which will be a crawler running surface (see FIGS. 1A to 1C) and by extending in the crawler width direction intersecting the crawler circumferential direction (see FIG. 2A). In this embodiment, two kinds of rubber lugs 11 having lengths extending in the crawler width direction different from each other are alternately arranged at a constant pitch in the crawler circumferential direction (see FIG. 2A). It is to be noted that the rubber lug 11 may have any shape and may be arranged in any manner as far as the purpose of this disclosure is achieved.

In this embodiment, cores 12 extend in the crawler width direction that corresponds to arrangement of each rubber lug 11 (see FIG. 2A) and are embedded on the crawler inner circumferential side of each rubber lug 11 (see FIGS. 1A to 1C), the length in the extending direction thereof being shorter than the rubber lug 11 (see FIG. 2A). The core 12 according to this embodiment has two protrusions 12a, 12a that are arranged in parallel to each other at approximately the center of each core 12 in the width direction and protruded to the inner circumferential side of the rubber elastic body, that is, to the inner circumferential side of the rubber crawler 10 (crawler inner circumferential side) (see FIGS. 2B and 2C). The two protrusions 12a, 12a, excepting at least an exposure portion 12b between both protrusions 12a, 12a, are thinly covered by the rubber elastic body (see FIG. 2C). The two protrusions 12a, 12a are guided by a track roller on the machine body side (not illustrated), and thus the sprocket S is guided such that it locates between these two protrusions 12a, 12a. As a result the rubber crawler 10 is wound around the sprocket S.

It is to be noted that the core 12 may have any shape and may be arranged in any manner as far as the purpose of this disclosure is achieved.

A steel cord layer 10a extending in the crawler circumferential direction is disposed outside the core 12 on the outer circumferential side. The steel cord layer 10a is a reinforcing layer that regulates stretch of the rubber crawler 10 in the crawler circumferential direction.

In this embodiment, the sprocket engaging hole 13 is formed into a recess that is located lower than the exposure portion 12b by one level, the sprocket engaging hole 13 being opened, between each exposure portion 12b of adjacent cores 12, toward the crawler inner circumferential side which has approximately the same width as the crawler width direction width of the exposure portion 12b (see FIGS. 2B and 2C).

The sprocket engaging hole 13 is provided with a rubber film 14 such that the sprocket S engaged with the sprocket engaging hole 13 contacts the rubber film 14, and the rubber film 14 has a shape protruding toward the crawler inner circumferential side (see FIGS. 1A to 1C).

In this embodiment, the rubber film 14 connects each base of adjacent rubber lugs 11 to integrate them (see FIGS. 1A to 1C), and thus is formed into an approximately rectangular shape (see FIGS. 2A and 2B) in plan view viewed from the crawler inner circumferential side. Further, the rubber film 14 is formed into a thin film with a thickness of about 2 to 5 mm. Moreover, in this embodiment, the entire rubber film 14 has approximately the uniformed thickness (see FIGS. 1A to 1C and FIG. 2C) and is formed thin as described above. Thus the rubber film 14 is easily deformed and moved when contacting the sprocket S. This rubber film 14 forms the bottom of the sprocket engaging hole 13. The sprocket engaging hole 13 is closed by the rubber film 14 and does not pass through to the crawler outer circumferential side (see FIG. 2C).

In this embodiment, in the rubber film 14 having a shape protruding toward the crawler inner circumferential side, a cross-sectional shape along the crawler circumferential direction is formed into a curve shape where the crawler inner circumferential side is a lowest portion (see FIGS. 1A to 1C), and thus is formed into a shape protruding toward the crawler inner circumferential side. The rubber film 14 has the curve shape in the cross-sectional view along the crawler circumferential direction at any point in the crawler width direction, and the rubber film 14 extends linearly (flatly) in the cross-sectional view along the crawler width direction at any point in the crawler circumferential direction. In other words, the rubber film 14 has an approximately semicircular shape. The curve shape, and thus the protruded shape is not limited to the approximately semicircular shape according to this embodiment, and may be an approximately dome shape in which both a cross-sectional shape along the crawler width direction and a cross-sectional shape along the crawler circumferential direction are a curve shape where the crawler inner circumferential side is the lowest portion.

It is to be noted that, in view of an increased energizing elastic force by the rubber film 14, the protruded shape of the rubber film 14 may preferably be an approximately semicircular shape according to this embodiment.

When not contacting the sprocket S, the rubber film 14 is recessed toward the crawler inner circumferential side, and when contacting the sprocket S, the rubber film 14 is raised toward the crawler outer circumferential side. Thereafter when the contact with the sprocket S is released, the rubber film 14 returns to its original recessed state. In this manner, since the rubber film 14 has a shape protruding toward the crawler inner circumferential side, it has an energizing elastic force that allows for repetition of a series of states in which the rubber film returns to the recessed state after being raised.

In this embodiment, at least a part of the rubber film 14 is located further on the crawler inner circumferential side than the center of the core 12 in the thickness direction. In this example, its peripheral edge that includes the lowest portion of the curve is located further on the crawler inner circumferential side than the center of the core 12 in the thickness direction (see FIG. 1A). The aforementioned configuration allows the rubber film 14 to be located further closer to the crawler inner circumferential side, and thus the sprocket S engaged with the sprocket engaging hole 13 can be more securely in contact with the rubber film 14. Therefore, as described below, mud M or the like can be securely removed from the rubber crawler 10.

In this manner, the rubber crawler 10 according to this embodiment is formed such that the crawler inner circumferential side will be the lowest portion to allow the rubber film 14, which is a bottom of the sprocket engaging hole 13 to be engaged with the sprocket S, to be recessed toward the crawler inner circumferential side, which is a side to be engaged with the sprocket S (see FIG. 1A). Thus, even if mud M or the like enters a recess 15 near the rubber film 14 between adjacent rubber lugs 11 on the crawler outer circumferential side (see FIG. 1B), when the sprocket S is driven and the rubber crawler 10 is wound around the sprocket S, the rubber film 14 is pushed by the tooth T of the sprocket S and is raised to the crawler outer circumferential side (see FIG. 1C). Thus the mud M entered and adhered to the recess 15 between rubber lugs 11 is pushed, while being split, out from the recess 15 between the rubber lugs 11 (see FIG. 1C). As a result, the mud adhered between the rubber lugs 11 on the crawler outer circumferential side can be removed.

Therefore, in this embodiment, the rubber film 14, which is a bottom of the sprocket engaging hole 13, contacts the tooth T of the sprocket S when the rubber crawler 10 is wound around the sprocket S, and is deformed so as to protrude toward the crawler outer circumferential side (see FIG. 1C). Thus the rubber film 14 pushes and splits the mud M adhered to the recess 15 between adjacent rubber lugs 11, and the mud M is removed from the recess 15 between rubber lugs 11. As such, the rubber film 14 will be a starting point of removal of mud M from the recess 15 between rubber lugs 11 of the rubber crawler 10. The rubber film 14 as a starting point removes mud M from the recess 15 between rubber lugs 11, which induces removal of M from other portions between the rubber lugs 11 on the crawler outer circumferential side, and removal of mud M from the entire crawler outer circumferential side is sequentially induced.

Moreover, in this embodiment, the sprocket engaging hole 13 is closed without passing through to the crawler outer circumferential side by providing the rubber film 14. Thus mud M or the like is prevented from entering from the crawler outer circumferential side into the crawler inner circumferential side through the sprocket engaging hole 13.

The deformation of this rubber film 14 caused by being pushed to the crawler outer circumferential side is repeated when contacting the tooth T of the sprocket S each time when the rubber crawler 10 according to this embodiment is wound around the sprocket S. Thus, in each case mud M or the like adhered to the recess 15 between adjacent rubber lugs 11 can be removed from the recess 15 between adjacent rubber lugs 11. Therefore, when the rubber crawler 10 according to this embodiment is used as a rubber crawler for agricultural machinery in the field or the like, for example, even if mud M or the like adheres to the crawler outer circumferential side of the rubber crawler 10, mud M or the like can be effectively removed from the rubber crawler 10 any time while working in the field.

Next, a rubber crawler according to another embodiment of this disclosure will be described.

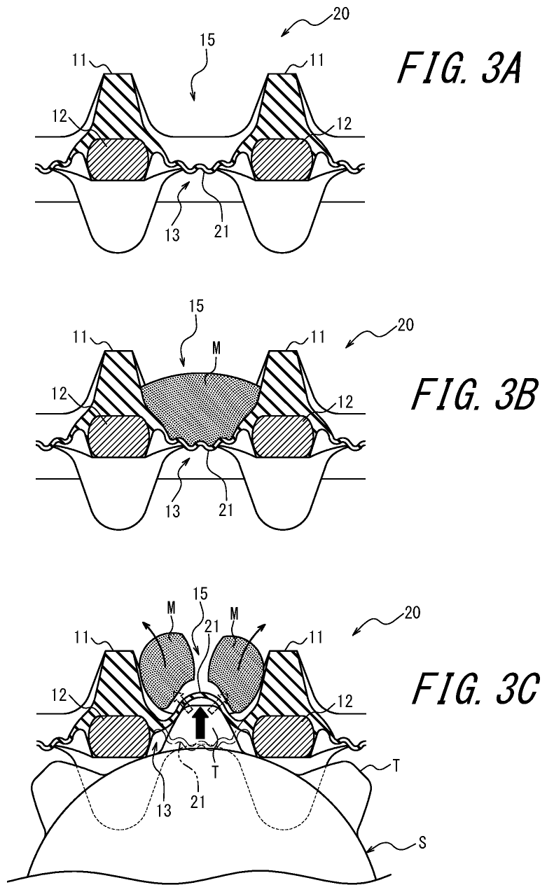

The rubber crawler 20 illustrated in FIGS. 3A to 3C has a rubber film 21 instead of the rubber film 14. Other configurations and actions are the same as those of the aforementioned rubber crawler 10.

In this embodiment, in the rubber film 21 having a shape protruding toward the crawler inner circumferential side, a cross-sectional shape along the crawler circumferential direction is formed into a curve shape where the crawler inner circumferential side is a lowest portion (see FIGS. 3A to 3C), and thus is formed into a shape protruding toward the crawler inner circumferential side. The rubber film 14 has the curve shape in the cross-sectional view along the crawler circumferential direction at any point in the crawler width direction. The rubber film 14 has a wave-like shape, in which the crawler circumferential direction is a wavelength direction, in the cross-sectional view along the crawler circumferential direction at any point in the crawler width direction. In other words, the rubber film 14 has an approximately semicircular shape including the wave-like shape in which the crawler circumferential direction is a wavelength direction. Due to the rubber film 21 formed into a wave-like shape, an overall approximately semicircular curve shape is obtained, in which the entire crawler width direction has a cross-sectional shape along the crawler circumferential direction and the upper surface takes on a wave-like shape.

The curve shape and thus the protruded shape is not limited to the approximately semicircular shape according to this embodiment, and may be an approximately dome shape in which both a cross-sectional shape along the crawler width direction and a cross-sectional shape along the crawler circumferential direction are a curve shape in which the crawler inner circumferential side is a lowest portion.

It is to be noted that, in view of an increased energizing elastic force by the rubber film 21, the protruded shape of the rubber film 21 may preferably be an approximately semicircular shape according to this embodiment.

When the rubber film 21 is formed into a wave-like shape in which the crawler circumferential direction is a wavelength direction, a wave-like curve surface is continuously repeated along the crawler circumferential direction (see FIGS. 3A to 3C), and as a result, the flexibility of the rubber film 21 is improved to allow the rubber film 21 to be deformed easily, and further to allow the rubber film 21 difficult to be torn by repeated deformations due to contact with the tooth T of the sprocket S.

In this manner, the rubber crawler 20 according to this embodiment is formed such that the crawler inner circumferential side will be the lowest portion to allow the rubber film 21, which will be a bottom of the sprocket engaging hole 13 to be engaged with the sprocket S, to be fallen to the crawler inner circumferential side, which is a side to be engaged with the sprocket S (see FIG. 3A). Thus, even if mud M or the like enters the recess 15 near the rubber film 14 between adjacent rubber lugs 11 on the crawler outer circumferential side and adheres thereto (see FIG. 3B), when the sprocket S is driven and the rubber crawler 20 is wound around the sprocket S, the rubber film 21 is pushed by the tooth T of the sprocket S and protrudes toward the crawler outer circumferential side while the wave-like curve is stretched gradually (see FIG. 3C). As a result mud M or the like entered the recess 15 between rubber lugs 11 and adhered thereto is pushed out from the recess 15 between rubber lugs 11 while being split (see FIG. 3C).

Therefore, also in this embodiment, the rubber film 21, which will be a bottom of the sprocket engaging hole 13, deforms toward the crawler outer circumferential side when the rubber crawler 20 is wound around the sprocket S and the tooth T of the sprocket S contacts the rubber film 21 (see FIG. 3C). Then the rubber film 21 pushes and splits mud M or the like adhered to the recess 15 between adjacent rubber lugs 11 to remove the mud M from the recess 15 between adjacent rubber lugs 11. Thus the rubber film 24 will be a starting point of removing mud M or the like from the recess 15 between rubber lugs 11 of the rubber crawler 20. The rubber film 21 as a starting point of removing mud M or the like removes mud M from the recess 15 between rubber lugs 11, which induces removal of M from other portions between the rubber lugs 11 on the crawler outer circumferential side, and removal of mud M from the entire crawler outer circumferential side is sequentially induced.

Moreover, also in this embodiment, the sprocket engaging hole 13 is closed without passing through to the crawler outer circumferential side by providing the rubber film 21. Thus mud M or the like is prevented from entering from the crawler outer circumferential side into the crawler inner circumferential side through the sprocket engaging hole 13.

### REFERENCE SIGNS LIST

10, 20 Rubber crawler
10a Steel cord layer
11 Rubber lug
12 Core
12a Protrusion
12b Exposure portion
13 Sprocket engaging hole
14, 21 Rubber film
15 Recess
M Mud
S Sprocket
T Tooth

1. A rubber crawler having a rubber lug formed on an outer circumferential side of an endless rubber elastic body, inside the rubber elastic body being disposed with cores at a constant pitch in a crawler circumferential direction, and between the cores adjacent to each other in the crawler circumferential direction is formed with a sprocket engaging hole to be engaged with a sprocket, wherein
a rubber film is provided for the sprocket engaging hole, and the rubber film has a shape protruding toward a crawler inner circumferential side.

2. The rubber crawler according to claim 1, wherein at least a part of the rubber film is located further on the crawler inner circumferential side than a center of the core in a thickness direction.

3. The rubber crawler according to claim 1, wherein the rubber film has a wave-like shape in which the crawler circumferential direction is a wavelength direction.

4. The rubber crawler according to claim 2, wherein the rubber film has a wave-like shape in which the crawler circumferential direction is a wavelength direction.
